(19) United States
(12) Patent Application Publication
(10) Pub. No.: US 2009/0184905 A1
(43) Pub. Date: Jul. 23, 2009

(54) DISPLAY APPARATUS

(75) Inventors: Lung DAI, Tu-Cheng (TW); Zhi-Peng MA, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/241,095

(22) Filed: Sep. 30, 2008

(30) Foreign Application Priority Data
Jan. 22, 2008 (CN) 200810300185.2

(51) Int. Cl. G09G 3/32

(52) U.S. Cl. 345/82

(57) ABSTRACT

A display apparatus includes a display panel, a front cover attached to the display panel, a plurality of emitting units disposed on the front cover, and a switching unit. The display panel is used for displaying images. The emitting unit is used for receiving power from a power module and emitting light in different colors. The switching unit is used for controlling an electrical connection between the power module and the emitting unit. When the display panel is powered off, the switching unit closes the electrical connection.

### BACKGROUND

1. Technical Field

The disclosed embodiments relate to display apparatuses, and more particularly, relate to a display apparatus capable of emitting light in different colors.

2. Description of Related Art

Display apparatuses, particularly flat panel display apparatuses, are widely used in various products, such as computers, televisions, mobile phones, and so on. Generally, a display apparatus includes a casing and a display panel received in the casing. It is known that casings with esthetic and ostentatious appearance can be attractive to potential buyers. Therefore, it is important that display casings be embedded with the above qualities for business purposes.

However, for various types of the flat panel display apparatuses, the color of the casing is usually black or silvery white. Casings with monotone color have uninteresting and boring appeal, especially when the display apparatus is turned off.

Therefore, a need exists for a display apparatus to resolve the above problem.

### SUMMARY

A display apparatus includes a display panel, a front cover attached to the display panel, a plurality of emitting units disposed on the front cover, and a switching unit. The display panel is used for displaying images. The emitting unit is used for receiving power from a power module and emitting light in different colors. The switching unit is used for controlling an electrical connection between the power module and the emitting unit. When the display panel is powered off, the switching unit closes the electrical connection.

Other advantages and novel features will become more apparent from the following detailed description of embodiments when taken in conjunction with the accompanying drawings.

### BRIEF DESCRIPTION OF THE DRAWINGS

FIG. 1 is a front view of a display apparatus in accordance with an exemplary embodiment.

FIG. 2 is a block diagram showing functional modules of the display apparatus.

FIG. 3 is a circuit diagram showing detailed circuits of the display apparatus of FIG. 2.

### DETAILED DESCRIPTION

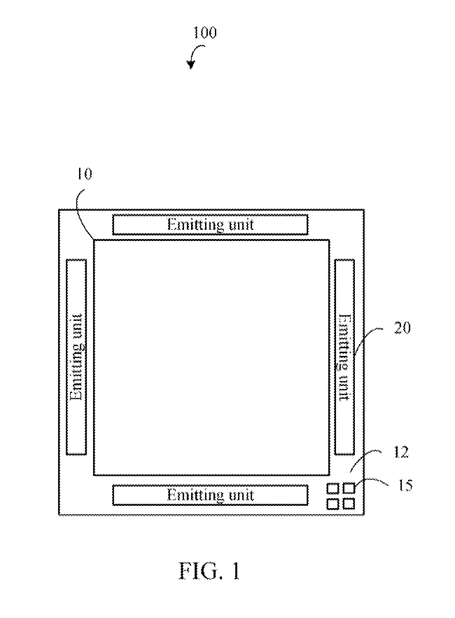

Referring to FIG. 1, a display apparatus 100 includes a display panel 10, a front cover 12, and a plurality of emitting units 20. The display panel 10 is accommodated in a space defined by an assembled casing formed by the front cover 12 and a rear cover (not shown). The display panel 10 can be a liquid crystal display (LCD) panel, or any other flat display panels.

The front cover 12 is defined with an opening (not labeled) in an approximately central portion for light to pass through, and is composed of four successively connected side frames (not labeled). The emitting units 20 are disposed on the front cover 12, and near the display panel 10. Each emitting unit 20 is composed of a plurality of light emitting diodes (LEDs). When the display panel 10 is powered off, the emitting unit 20 emits light in different colors. When the display panel 10 is powered on, the emitting unit 20 stops emitting light. In other embodiments, each emitting unit 20 may be composed of a plurality of organic light emitting diodes (OLEDs).

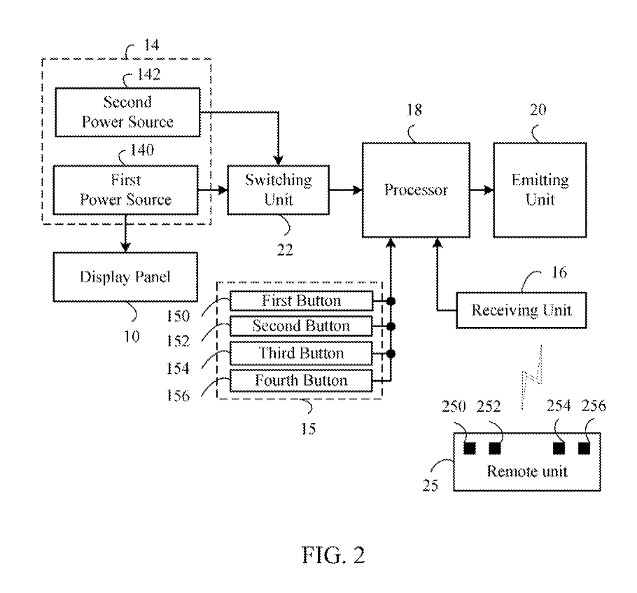

Also referring to FIG. 2, the display apparatus 100 further includes a power module 14, a plurality of buttons 15 disposed on the front cover 12, a receiving unit 16, a processor 18, and a switching unit 22. The power module 14 includes a first power source 140 and a second power source 142. The first power source 140 is used for supplying a first power. The display panel 10 receives the first power and displays images. The second power source 142 supplies a second power to the processor 18 via the switching unit 22, and correspondingly the processor 18 drives the emitting unit 20 to emit light in different colors. The switching unit 22 controls an electrical connection between the second power source 142 and the processor 18.

In the embodiment, when the first power source 140 supplies the first power to the display panel 10, the switching unit 22 is unactivated. When the first power source 140 stops supplying the first power, the switching unit 22 is activated and closes the electrical connection. Therefore, the processor 18 receives the second power from the second power source 142, and drives the emitting unit 20 to emit light in different colors.

The buttons 15 is used for generating control signals when depressed, and sending the control signals to the processor 18. Based on the control signals, the processor 18 drives the emitting unit 20 to emit light in at least one color or controls the emitting unit 20 to stop emitting light. In detail, the buttons 15 includes a first button 150, a second button 152, a third button 154, and a fourth button 156. When the first button 150, the second button 152, and the third button 154 are depressed, the processor 18 drives the emitting unit 20 to emit light in red color, in blue color, and in green color respectively. When the fourth button 156 is depressed, the processor 18 controls the emitting unit 20 to stop emitting light.

The receiving unit 16 is used for receiving commands from a remote unit 25, and based on these commands, the processor 18 drives the emitting unit 20 to emit light in at least one color or controls the emitting unit 20 to stop emitting light. In detail, the remote unit 25 includes a first key 250, a second key 252, a third key 254, and a fourth key 256. The first key 250, the second key 252, the third key 254, and the fourth key 256 perform the same functions as the first button 150, the second button 152, the third button 154, and the fourth button 156 respectively.

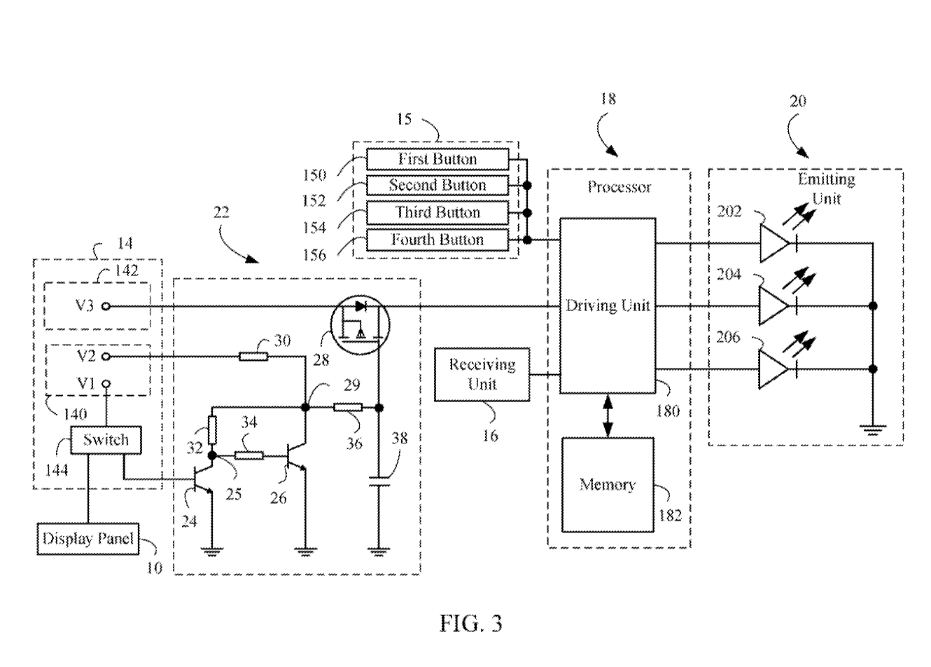

Also referring to FIG. 3, the processor 18 includes a driving unit 180 and a memory 182. The memory 182 stores a program. The emitting unit 20 includes a first light emitting diode (LED) 202, a second LED 204, and a third LED 206. The driving unit 180 is used for invoking the program and driving the first LED 202, the second LED 204, and the third LED 206 to emit light in red color, in blue color, and in green color respectively.

As the red light, blue light and green light are mixed together with varying proportion, light in different colors are generated.

The switching unit 22 includes a first bipolar junction transistor (BJT) 24, a second BJT 26, a p-channel metal oxide semiconductor (PMOS) transistor 28, a capacitor 38, and four resistors 30, 32, 34, 36.

The power module 14 further includes a switch 144. The first power source 140 supplies a first voltage V1 and a second voltage V2. The display panel 10 is connected to the first voltage V1 via the switch 144. The base of the first BJT 24 is connected to the first voltage V1 via the switch 144, the collector of the first BJT 24 is connected to a first node 25, and the emitter of the first BJT 24 is grounded. The first node 25 is connected to the second voltage V2 via the resistor 30 and the resistor 32. The base of the second BJT 26 is connected to the collector of the first BJT 24 via the resistor 34, the collector of the second BJT 26 is connected to a second node 29, and the emitter of the second BJT 26 is grounded. The second node 29 is connected to the second voltage V2 via the resistor 30.

The second power source 142 supplies a third voltage V3. A drain of the PMOS transistor 28 is connected to the third voltage V3, a source of the PMOS transistor 28 is connected to the processor 18, and a gate of the PMOS transistor 28 is connected to the collector of the second BJT 26 via the resistor 36. One end of the capacitor 38 is connected to the gate of the PMOS transistor 28, and the other end of the capacitor 38 is grounded.

When the switch 144 is turned on, the display panel 10 receives the first voltage V1 and is powered on. The base of the first BJT 24 receives the first voltage V1 from the first power source 140, and the first BJT 24 is turned on. Thus, the voltage of the node 25 is pulled down lower than the turn-on voltage for the second BJT 26. Consequently, the second BJT 26 is turned off. The voltage of the node 29 is pulled up higher than the turn-off voltage for the PMOS transistor 28, thus the PMOS transistor 28 is turned off. Therefore, the driving unit 180 cannot receive the third voltage V3, and stops driving the emitting unit 20 to emit light correspondingly.

When the switch 144 is turned off, the first voltage V1 to the display panel 10 and to the base of the first BJT 24 is disconnected, so the display panel 10 and the first BJT 24 is off. Thus, the voltage of the node 25 is pulled up higher than the turn-on voltage for the second BJT 26. Consequently, the second BJT 26 is turned on. The voltage of the node 29 is pulled down lower than the turn-off voltage for the PMOS transistor 28, thus the PMOS transistor 28 is turned on. Therefore, the driving unit 180 receives the third voltage V3, and drives the emitting unit 20 to emit different color light correspondingly.

As mentioned above, in the embodiment, the display apparatus 100 utilizes the switching unit 22 to control the electrical connection between the second power source 142 and the processor 18. When the first power source 140 stops supplying the first power, that is, the display panel 10 is powered off, the switching unit 22 is turned on and closes the electrical connection. Thus, the processor 18 receives the second power from the second power source 142 and controls the emitting unit 20 to emit light in different colors. Therefore, the display apparatus 100 has good visual effects and a nice varying appearance when the display panel 10 is powered off.

Alternative embodiments will become apparent to those skilled in the art to which the present invention pertains without departing from the spirit and scope. Accordingly, the present invention should be deemed not to be limited to the above detailed description, but rather by the claims that follow.

What is claimed is:

1. A display apparatus comprising:
a display panel for displaying images;
a front cover attached to the display panel;
a plurality of emitting units disposed on the front cover for receiving power from a power module and emitting light in at least one color; and
a switching unit for controlling opening and closing of an electrical connection between the power module and the emitting unit according to operation state of the display panel.

2. The display apparatus as claimed in claim 1, wherein when the display panel is powered on, the switching unit opens the electrical connection; when the display panel is powered off, the switching unit closes the electrical connection.

3. The display apparatus as claimed in claim 1, wherein the display apparatus further comprises a processor for driving the emitting unit to emit light in different colors, the power module comprises a first power source and a second power source, the first power source is used for supplying a first power to the display panel, the second power source is used for supplying a second power to the processor.

4. The display apparatus as claimed in claim 3, wherein when the first power source supplies the first power to the display panel, the switching unit is unactivated; when the first power source stop supplying the first power, the switching unit is activated.

5. The display apparatus as claimed in claim 4, wherein the first power source supplies a first voltage V1 and a second voltage V2, the second power source supplies a third voltage V3, the power module further comprises a switch, the display panel is connected to the first voltage V1 via the switch, the switching unit comprises a first BJT, a second BJT, and a PMOS transistor, the base of the first BJT is connected to the first voltage V1 via the switch, the emitter of the first BJT is grounded, and the collector of the first BJT is connected to the second voltage V2; the base of the second BJT is connected to the collector of the first BJT, the emitter of the second BJT is grounded, and the collector of the second BJT is connected to the second voltage V2; the drain of the PMOS transistor is connected to the third voltage V3, the gate of the PMOS transistor is connected to the collector of the second BJT, and the source of the PMOS transistor is connected to the processor.

6. The display apparatus as claimed in claim 5, wherein when the switch is turned on, the display panel and the base of the first BJT receive the first voltage V1 from the first power source, when the switch is turned off, the display panel and the base of the first BJT cannot receive the first voltage V1.

7. The display apparatus as claimed in claim 5, wherein the collector of the second BJT is connected to the power supply via a resistor.

8. The display apparatus as claimed in claim 5, wherein the collector of the first BJT is connected to the collector of the second BJT via a resistor.

9. The display apparatus as claimed in claim 5, wherein the base of the second BJT is connected to the collector of the first BJT via a resistor.

10. The display apparatus as claimed in claim 5, wherein the switching unit further comprises a capacitor, one end of the capacitor is connected to the gate of the PMOS transistor, and the other end of the capacitor is grounded.

11. The display apparatus as claimed in claim 5, wherein the gate of the PMOS transistor is connected to the collector of the second BJT via a resistor.

12. The display apparatus as claimed in claim 3, wherein the processor comprises a driving unit and a memory for storing a program, the emitting unit comprises a first LED, a second LED and a third LED, the driving unit is used for invoking the program and driving the first LED, the second LED and the third LED to emit light in red color, in blue color and in green color respectively.

13. The display apparatus as claimed in claim 12, wherein the display apparatus further comprises a plurality of buttons disposed on the front cover, if the buttons are depressed, the driving unit drives the emitting unit to emit light in at least one color or controls the emitting unit to stop emitting light.

14. The display apparatus as claimed in claim 13, wherein the buttons comprise a first button, a second button, a third button, and a fourth button, when the first button is depressed, the driving unit only drives the first LED to emit light in red color, when the second button is depressed, the driving unit only drives the second LED to emit light in blue color, when the third button is depressed, the driving unit only drives the third LED to emit light in green color, when the fourth button is depressed, the driving unit stop driving the first LED, the second LED, and the third LED to emit light.

15. The display apparatus as claimed in claim 12, wherein the display apparatus comprises a receiving unit, the receiving unit is used for receiving commands from a remote unit, based on the commands, the driving unit drives the emitting unit to emit light in at least one color or controls the emitting unit to stop emitting light.

16. The display apparatus as claimed in claim 15, wherein the remote unit comprises a first key, a second key, a third key, and a fourth key, when the first key is depressed, the driving unit only drives the first LED to emit light in red color, when the second key is depressed, the driving unit only drives the second LED to emit light in blue color, when the third key is depressed, the driving unit only drives the third LED to emit light in green color, when the fourth key is depressed, the driving unit stop driving the first LED, the second LED, and the third LED to emit light.

17. The display apparatus as claimed in claim 12, wherein when the red light, the blue light, and the green light are mixed together with varying proportion, light in different colors are generated.

18. A display apparatus comprising:
a display panel for displaying images;
a front cover attached to the display panel;
a plurality of emitting units disposed on the front cover for receiving power from a power module and emitting light in at least one color;
a switching unit for controlling an electrical connection between the power module and the emitting unit; and
wherein the switching unit closes the electrical connection when the display panel is powered off.

19. The display apparatus as claimed in claim 18, wherein when the display panel is powered on, the switching unit opens the electrical connection.
